(19) United States
(12) Patent Application Publication
(10) Pub. No.: US 2006/0137445 A1
(43) Pub. Date: Jun. 29, 2006

(54) Isolated temperature sensor for humidification system

(76) Inventors: Malcolm David Smith, Auckland (NZ); Stephen William McPhee, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/523,132

(22) PCT Filed: Jul. 25, 2003
(86) PCT No.: PCT/NZ03/00164

§ 371 Date: Aug. 29, 2005

(30) Foreign Application Priority Data
Jul. 31, 2002 (NZ) 520513

(51) Int. Cl. G01F 1/68

(52) U.S. Cl. 73/204.22

(57) ABSTRACT

This invention relates to gases distribution systems and in particular, to temperature sensors. The sensor of the present invention is configured to determine the temperature of a flow of respiratory gases and comprises a sensor housing (36) configured for positioning proximate to a flow of gases and a temperature transducer (31) housed within the sensor housing (36). The sensor housing (36) provides a substantial pathogen barrier between the flow of gases and the temperature transducer (31), but permits the temperature transducer to provide a substantial indication of the temperature of the flow of gases. In particular, the temperature of the gases is remotely sensed via a conductive path (38) through the wall of the breathing circuit (14). This conductive path (38), integral to the breathing circuit (14), could then be disposed of or reused after suitable sterilisation.

### FIELD OF THE INVENTION

This invention relates to gases distribution systems and in particular, though not solely, to respiratory humidification systems which humidify gases for a patient, or other person in need of such gases, to breathe.

### BACKGROUND OF THE INVENTION

Many, if not all, existing respiratory humidification systems which deliver humidified gases (such as oxygen or anaesthetic gases) to a patient, or other person in need of such gases, operate as temperature controllers. That is, the temperature of the gases leaving the humidification device in the breathing circuit is monitored and the heat source controlled in response to changes in that temperature to achieve a desired outgoing humidified gases temperature. An example of this type of humidifier control system is disclosed in our prior U.S. Pat. No. 5,558,084.

These prior art systems we temperature probes which measure the temperature of the gas at various parts of the respiratory circuit This method has some drawbacks:
1. The probes need to be sterilised after use on each patient to prevent cross contamination
2. The probes need to be plugged in filly to ensure that the temperature of the respiratory gas is measured correctly.
3. The probes call be accidentally left out of the breathing circuit
4. The probes must maintain a gas tight seal with the breathing circuit
5. The probes must be of robust design

### SUMMARY OF THE INVENTION

It is therefore an object of the present invention to provide a respiratory humidification system and sensor which will go at least some way towards overcoming the above disadvantages or which at least provide the industry with a useful choice.

Accordingly, in a first aspect, the present invention consists in, a sensor configured to determine a parameter of a flow of respiratory gas comprising:

a temperature transducer, configured for positioning adjacent said flow of gas,

a sensor housing configured to house said transducer and provide a substantial pathogen barrier to said flow of gas; and

a conductive path between said transducer and said flow of gas.

In a second aspect the present invention consists in a system for conveying a flow of respiratory gas comprising:

a conduit adapted to convey said flow of gases,

a thermally conductive member extending from the interior of said conduit in contact with said flow of gas to the exterior of said conduit, and

an external engagement for a temperature sensor engaging said member which does not protrude into said conduit.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

One preferred form of the present invention will now be described with reference to the accompanying drawings in which;

FIG. 1A is a longitudinal cross section of a temperature sensor located inside a protrusion in the circuit wall according to one preferred embodiment of the present invention,

FIG. 1B is a transverse cross section of a temperature sensor located inside a protrusion in the circuit wall according to one preferred embodiment of the present invention,

FIG. 2A is a longitudinal cross section of a temperature sensor which contacts a thermally conductive probe according to a further preferred embodiment of the present invention,

FIG. 2B is a transverse cross section of a temperature sensor which contacts a thermally conductive probe according to a further preferred embodiment of the present invention,

FIG. 3A is a longitudinal cross section of a temperature sensor which contacts a thermally conductive strip according to a still further preferred embodiment of the present invention,

FIG. 3B is a transverse cross section of a temperature sensor which contacts a thermally conductive strip according to a still further preferred embodiment of the present invention,

FIG. 4A is a longitudinal cross section of a temperature sensor which contacts a thermally conductive band according to another preferred embodiment of the present invention, and

FIG. 4B is a transverse cross section of a temperature sensor which contacts a thermally conductive band according to another preferred embodiment of the present invention, and

FIG. 5 is a temperature sensor embedded into an electrical connector according to another preferred embodiment of the present invention, and

FIG. 6 is a schematic diagram of a respiratory humidification system incorporating temp sensors.

FIG. 7 is a temperature sensor embedded in a connector.

FIG. 8 is a temperature sensor embedded in a clamping device.

### DETAILED DESCRIPTION OF THE PREFERRED EMBODIMENT

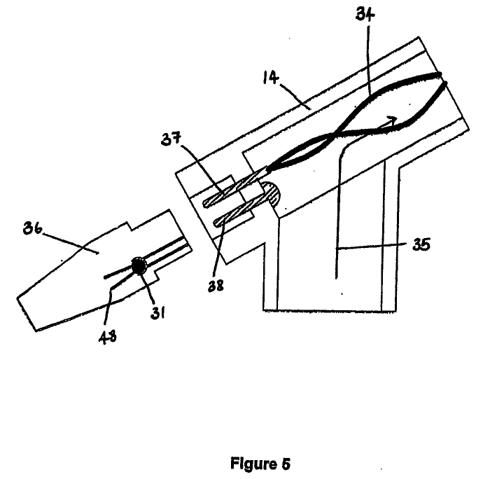

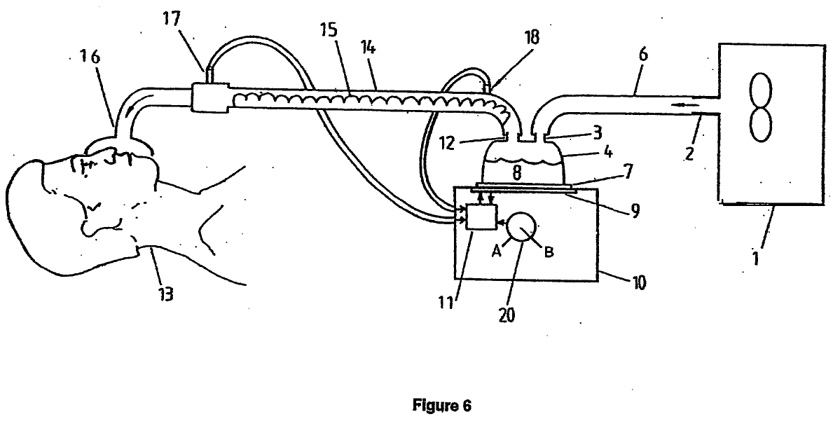

With reference to the accompanying drawings and in particular to FIG. 6, an example humidification apparatus or respiratory humidification system incorporating preferred embodiments of the present invention is illustrated. Included in the respiratory humidification system is a ventilator, gases supply means or blower 1 having an outlet 2 which supplies gases (for example oxygen, anaesthetic gases or air) to the inlet 3 of a humidification chamber means 4 via a conduit 6. Humidification chamber means 4 may, for example comprise a plastics formed chamber having a metal base 7 sealed thereto. Humidification chamber 4 is adapted to hold a volume of water 8 which is heated by a heater plate means 9 under the control of a controller or control means 11 of a humidification device or humidifier 10.

As the water 8 within chamber 4 is heated it slowly evaporates, mixing water vapour with the gases flowing through the humidification chamber 4. Accordingly, humidified gases leave humidification chamber 4 via outlet 12 and are passed to a patient or other person in need of such gases 13 through a gases transportation pathway or inspiratory conduit 14. In order to reduce condensation within the inspiratory conduit 14 and to raise the temperature of the gases provided to the patient 13 a heating wire means 15 may be provided which may be energised under the control of control means 1.

In FIG. 6 a gases mask 16 is shown over the patient's nose and mouth (referred to as “Intact Airways” gases delivery) however it should be understood that many gases delivery configurations exist such as intubation in which a delivery tube is positioned in the patient's trachea to by-pass the patient's airways known as “Intubated Airways” gases delivery). It is also possible to provide a return path for the patient's exhaled gases back to ventilator 1. In this case a suitable fitting such as a “Y-piece” may be attached between the patient 13, inspiratory conduit 14 and an expiratory conduit (not shown) which is connected to an inlet (not shown) of ventilator 1.

Control means 11 may for example comprise a microprocessor or logic circuit with associated memory or storage means which stores software program which, when executed by the microprocessor logic circuit, controls the operation of the humidification system in accordance with instructions set of the software and also in response to external inputs. For example, control means 11 may be provided with input from heater plate 9 so that control means 11 is provided with information on the temperature and/or power usage of the heater plate 9. In addition, control means 11 could be provided with inputs of the temperature of the gases flow, for example a temperature sensing means or temperature probe 17 may be provided at or near the patient to indicate the gases temperature being received by the patient and a further temperature probe 18 maybe provided to indicate to control means 11 the temperature of the humidified gases flow as it leaves outlet 12 of humidification chamber 4.

A still further input to control means 11 may be user input means or switch 20 which could be used to allow a user (such as a health care professional or the patient themselves) to set a desired gases temperature of gases to be delivered or a desired gases humidity level to be delivered or alternatively other functions could be controlled by switch 20 such as control of the heating delivered by heater wire 15 or selecting from a number of automatic gases delivery configurations.

A number of preferred embodiments of the system (or parts thereof) set out above will now be described in more detail.

Temperature Probe

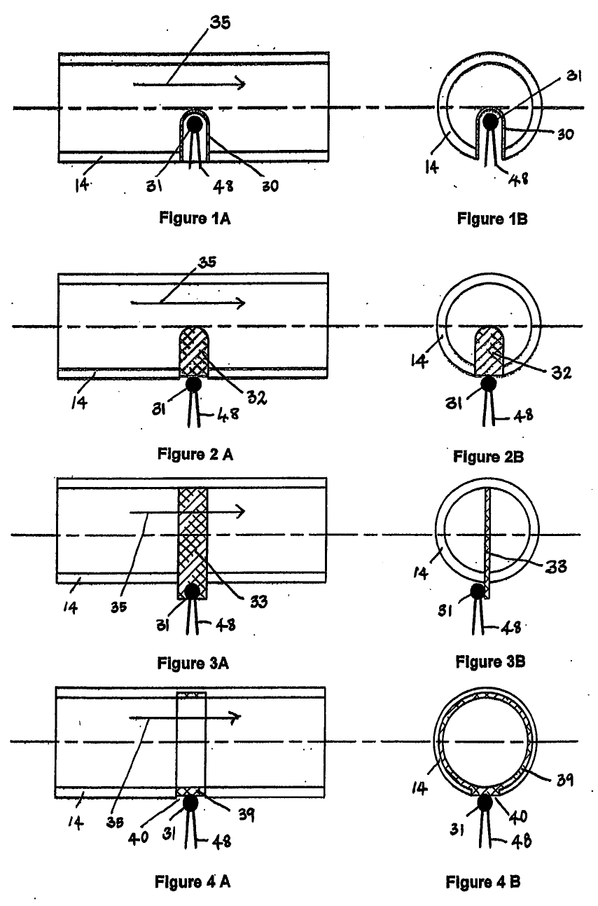

With reference to FIGS. 1 to 5, the various preferred forms of a temperature probe 17 or 18 are shown. The temperature probe 17 or 18 is preferably formed of a metal. Moulded plastics material such as polycarbonate could alternatively be used. The temperature sensor may be provided by any component whose electrical characteristics vary with temperature. In one embodiment of the present invention thermistor beads are used. The temperature sensor could be any temperature measuring device for example, thermocouple or RTD. The themistor beads are attached to wire conductors 48, which carry electrical signals to and from control means 11.

The present invention addresses the problems of the prior art by removing the need for the temperature probe to be inserted into the gas stream. Instead the temperature of the gas is remotely sensed via a conductive path through the wall of the break circuit. This conductive path, integral to the breathing circuit, could then be disposed of or reused after suitable sterilisation.

FIGS. 1 to 5 depict variations on this method. FIG. 1 shows a thin walled housing or membrane 30 which protrudes into the inspiratory conduit 14 and is part of the breathing circuit The temperature sensor 31 is located into this housing 30, making intimate contact with the housing 30 but not the flow of respiratory gas shown by arrow 35.

FIG. 2 depicts an alternative method in which the temperature sensor 31 connects to a thermally conductive probe 32, which is integral to the inspiratory circuit 14.

FIG. 3 shows a further improvement in which a conductive path for example a small blade of metal 33, crosses the entire path of the inspiratory conduit 14, thus giving a more robust design.

FIG. 4 shows a further improvement in which a thermally conductive band 39 around the entire circumference is sealed within conduit 14. Temperature sensor 31 is in intimate contact with the thermal band 39 through a small break 40 in conduit 14.

FIG. 5 depicts a method in, which the temperature sensor 31 is combined with an electrical connection, such as the heater wire connector plug 36. A thermally conductive terminal 38 protrudes into the inspiratory conduit 14. The advantage of this method is that both the electrical connection to the heater wire 34 and the thermal terminal 38 are made at the same time reducing the need for separate connections. Further to this, the respiratory humidifier can sense that the electrical connection has been made, via the electrical current, and therefore know that the temperature sensor 31 is also an intimate thermal contact with the breathing circuit 14.

FIG. 7 depicts a method in which the temperature sensor 31 is embedded in a connector plug 41. A thermally conducted probe 43 is integral to the inspiratory conduct 14 and the socket 42. When the plug 41 is inserted into the socket 42 the temperature sensor 31 connects to the thermally conductor probe 43.

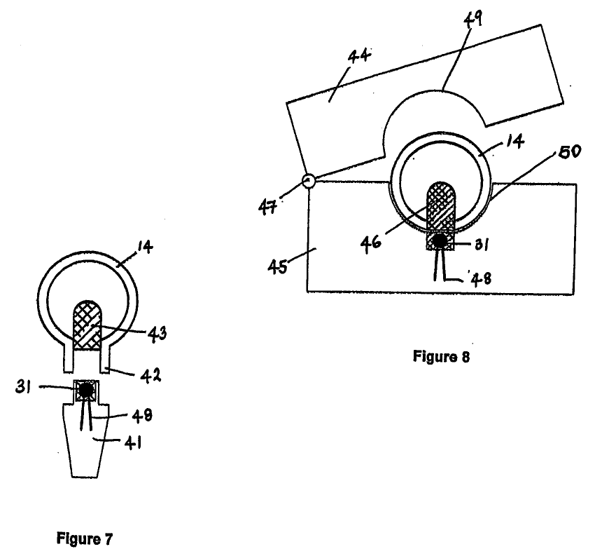

FIG. 8 depicts a method by which a thermally conducted probe 46 within conduit 14 may be held against temperature sensor 31. Holding means consist of two parts; part 45 and part 44, hinged by suitable hinging means 47 such that parts 45 and 44 may be moved apart to allow conduit 14 to be inserted into cut outs 49 and 50. Part 45 has temperature sensor 31 embedded within it and in use probe 46 within conduit 14 is in contact with temperature sensor 31.

With the temperature sensor located externally to the breathing circuit 14 unless the sensor is insulated from the ambient environment the temperature sensor will be affected by the ambient temperature. Compensation of this measurement error could be provided for in two ways:
1. The external ambient temperature is measured near the temperature sensor and then the temperature measurement error is compensated for by an equation or lookup table.
2. Control the ambient environment around the temperature sensor to a temperature near to the gas temperature thus reducing the effect of the ambient.

The above improvements address the short comings of the current temperature measurement methods used for respiratory humidification systems.

1. A sensor configured to determine a parameter of a flow of respiratory gas comprising:
a temperature transducer, configured for positioning adjacent said flow of gas,
a sensor housing configured to house said transducer and provide a substantial pathogen barrier to said flow of gas; and
a conductive path between said transducer and said flow of gas.

2. A sensor according to claim 1 wherein said sensor housing has a locator to ensure said transducer is correctly positioned and/or aligned.

3. A sensor according to claim 2 wherein said sensor housing is integrally moulded in a gases conduit for conveying said flow of gas.

4. A sensor according to claim 2 wherein said conductive path has a thermally conductive probe.

5. A sensor according to claim 4 wherein said conductive path crosses said flow of gas.

6. A sensor according to claim 4 wherein said conductive path is a band that said flow of gas flows within.

7. A sensor according to claim 3 wherein said sensor housing is combined with an engagement for an electrical connection.

8. A sensor according to claim 7 wherein said engagement for an electrical connection comprises an electrical contact adapted to energise a heater wire for heating said conduit or the interior thereof.

9. A sensor according to claim 1 wherein said sensor housing means has longitudinal axis substantially perpendicular to said flow of gas.

10. A system for conveying a flow of respiratory gas comprising:
a conduit adapted to convey said flow of gases,
a thermally conductive member extending from the interior of said conduit in contact with said flow of gas to the exterior of said conduit, and
an external engagement for a temperature sensor engaging said member which does not protrude into said conduit.

11. A system for conveying a flow of respiratory gas according to claim 10 wherein said engagement for a temperature sensor is adapted to ensure intimate contact of said exterior portion of said thermally conductive member and a temperature sensor.

12. A system for conveying a flow of respiratory gas according to claim 10 wherein said thermally conductive member comprises a thermally conductive housing.

13. A system for conveying a flow of respiratory gas according to claim 10 wherein said thermally conductive member comprises a thermally conductive probe.

14. A system for conveying a flow of respiratory gases according to claim 10 wherein said thermally conductive member comprises a conductive path that crosses the entire interior of said conduit.

15. A system for conveying a flow of respiratory gases according to claim 10 wherein said thermal conductive member comprises a conductive band within the circumference of said conduit.

16. A system for conveying a flow of respiratory gases according to claim 10 wherein said engagement for a temperature sensor is combined with an engagement for an electrical connection.

17. A system for conveying a flow of respiratory gases according to claim 11 further comprising a temperature sensor housed within a sensor housing.

18. A system for conveying a flow of respiratory gases according to claims 17 wherein said sensor housing is combined with an engagement for an electrical connection.

19. A system for conveying a flow of respiratory gases according to claim 18 wherein said sensor housing means has longitudinal axis substantially perpendicular to said flow of gases.

20. (canceled)

21. (canceled)
